(19) United States
(12) Patent Application Publication
(10) Pub. No.: US 2007/0077137 A1
(43) Pub. Date: Apr. 5, 2007

(54) Altitude density differential pressure induced draft powered wind turbine electric generating system

(76) Inventor: Danny Franklin Beard, Cartersville, GA (US)

Correspondence Address: Danny F. Beard, 170 Oakleaf Drive S.W., Cartersville, GA, 30120, US

(21) Appl. No.: 11/526,285

(22) Filed: Sep. 25, 2006

Related U.S. Application Data
(60) Provisional application No. 60/723,233, filed on Oct. 3, 2005.

(51) Int. Cl. F03D 7/06

(52) U.S. Cl. 415/4.2

(57) ABSTRACT

The idea that I am seeking to patent is the use of the difference in pressure between atmospheric elevations. When a conduit is placed between a higher elevation and a lower elevation the difference in altitude density will create an upward flow of air inside the conduit. My idea is to use this air flow to drive a Wind Turbine in order to generate electricity or to drive a mechanical device. The critical issue that makes my idea unique is that altitude density is the sole source of energy needed to drive the turbine (no heat input is required).

### FIELD OF INVENTION

1. Power Generation

### BACKGROUND OF INVENTION

1. I previously submitted a non-provisional application for this idea. No. 60/723,233 (Oct. 3, 2005).

2. A preliminary patentability search has been completed on this idea. I am attaching a copy for your benefit (ATTACHMENT A)

3. I am offering this background description and sending the enclosed attachment (ATTACHMENT A) in an effort to better explain my wind turbine idea. I intend to specifically illustrate how my idea is clearly different from any of the inventions that were patented as shown in the search information that was sent to me.

4. Not a single one of the patented ideas that I received encompasses the spirit of my invention. Although they do incorporate some of the aspects of my idea, there are distinct differences, I am going to point out, that make my idea patent worthy.

5. The critical aspect of my idea is that altitude density is the sole source used for powering the wind turbine that I have illustrated. This is accomplished by creating a differential pressure between two altitudes by connecting them with a conduit (stack or other means of creating an elevation differential). Therefore, with my idea, the important issues are: 1) The height of the stack 2) The square surface area at the base and up to the top of the stack & 3) Geographical location. The conduit does not have to be round nor does it have to be oriented at a 90 degree angle to ground elevation. None of these three issues appear to be significant aspects of the patented ideas I received.

6. Natural draft is generally defined as a draft that is not created by use of fans. Natural draft is usually and commonly created by using a source of energy to heat the air. The rising heated air creates an air flow. The spirit of the patented ideas I received is to use an energy source to heat the air and create a draft. This is not the spirit of my idea. (The only exception of the patented ideas was Mr. Clements'—His idea only deals with chimneys).

7. My idea does not require any source of energy input other than Altitude Density and or high altitude wind speed.

8. Excerpts from the patented ideas to illustrate the use of heating energy input are as follows:
U.S. Pat. No. 401,516 Robb “ . . . upon the sides which are exposed to the sun I have fixed glass disks or lenses B, the object of which is to receive and concentrate the heat of the sun's rays, so as to rarefy the air within the stack and increase the upward draft.” (lines 30-35)
U.S. Pat. No. 793,640 De Mier “ . . . the steam discharged from the exhaust serves to drive the fan . . . ” (lines 58-59)
U.S. Pat. No. 1,013,798 Messina “I have shown the chimney provided with a lamp for causing a draft, but, obviously, any other well known means could be employed for this purpose.” (lines 91-94)
U.S. Pat. No. 3,330,233 Clements—(I do not have a clue about what Mr. Clements' idea is except that it only deals with chimneys. Numbers of chimneys or designs of chimneys does not impact my idea at all—dfb).
U.S. Pat. No. 3,436,908 Van Delic “ . . . the invention disclosed depends upon the presence of the sun for its source of energy . . . ” (lines 67-68)
U.S. Pat. No. 3,936,652 Levine “A heat source heats air which rises in a duct . . . ”, “The heat source may be a heat exchanger connected to an atomic reactor, a fossil fuel plant, a solar collector, or a geothermal heat supply.” (-[57] ABSTRACT)
U.S. Pat. No. 4,016,725 Fiss “ . . . passing the heated water through the flow of air at generally the bottom thereof for cooling the heated water and heating the air to cause a natural draft flow of air up through the tower.” (-[57] ABSTRACT)
U.S. Pat. No. 4,118,636 Christian “ . . . a generally conical structure for collecting air and providing a confined space for solar heating of such air, connected, at the upper end of the conical structure, with a vertically placed electric generator through which the solar-heated air passes.” (-[57] ABSTRACT)

9. Hopefully, this explanation along with the attached drawings will help in understanding the difference between my idea and those that have been previously patented. I am convinced that my idea is distinct and patentable.

### SUMMARY OF INVENTION

1. I am seeking a patent on the following:
1) The use of altitude density differential pressure to supply the force to power an electric generating facility or to provide the force to power a mechanical device. This would include new or retrofitted facilities.
2) The use of altitude differential wind speed to provide (or assist with providing) the force to generate electricity or to provide the force to power a mechanical device. This also would include new or retrofitted facilities.

### BRIEF DESCRIPTION OF DRAWINGS

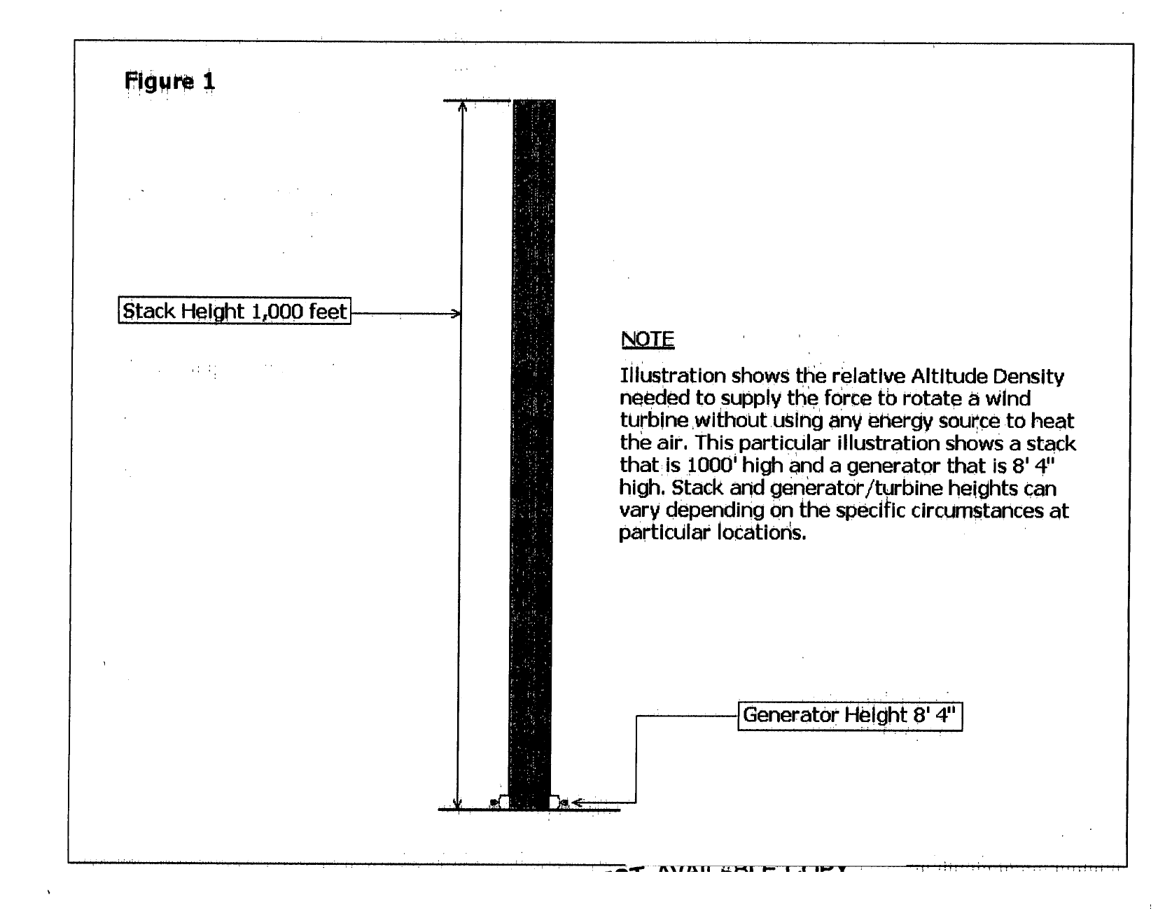

1. FIG. 1 illustrates how a smoke stack (this one 1000 feet tall) could be retrofitted with my idea to power one or more wind turbines.

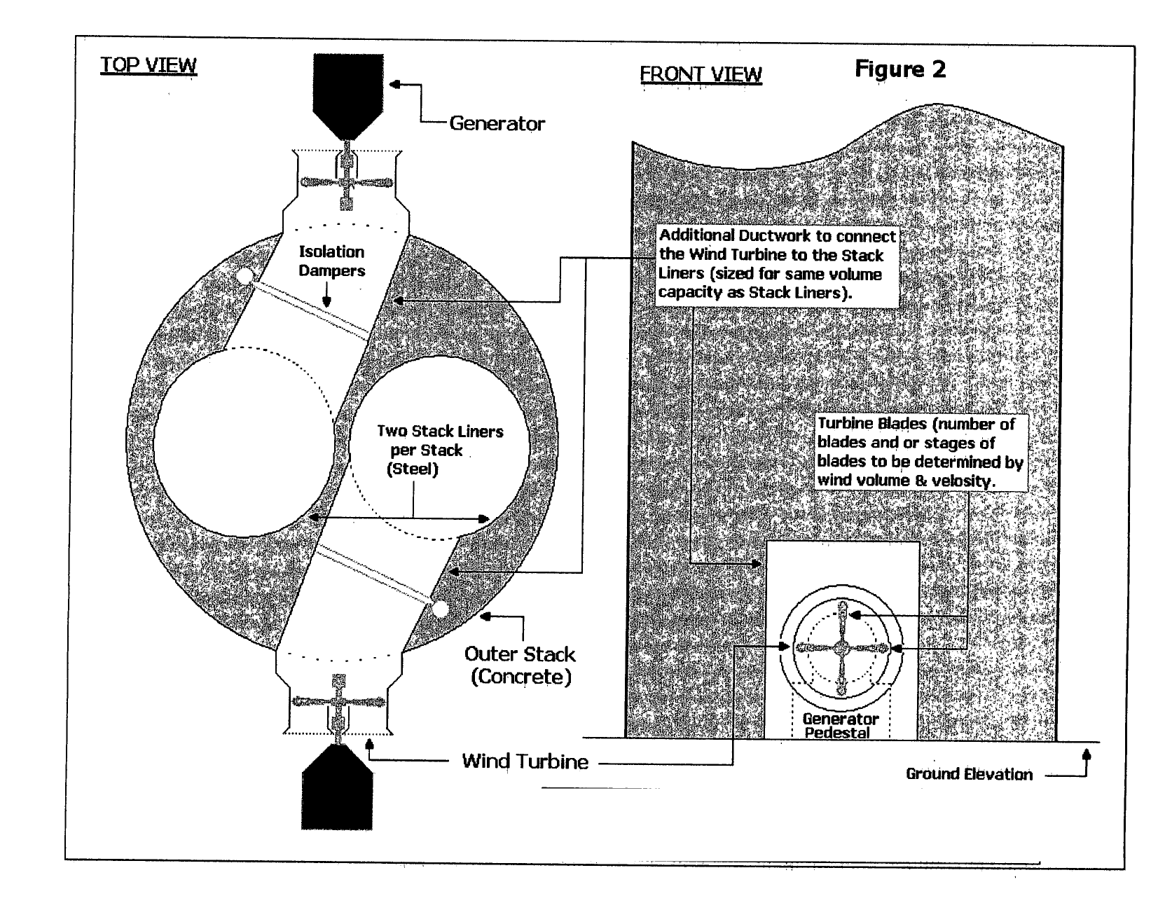

2. FIG. 2 illustrates how the turbine/generators could be configured in order to utilize the upward mass air flow to generate electricity.

### DETAILED DESCRIPTION

1. There are three factors that are important aspects of my idea:

1) The height of the conduit (in relation to altitude).
The greater the difference in altitude, the greater the difference in pressure.
The conduit does not have to be vertical. But,
Since most structures are vertical, this is the best probable configuration for retrofitting my idea. Example: Sulfur Dioxide Scrubbers are being installed at many fossil fuel electric generating plants. As a result of this, the old smoke stacks will be rendered virtually unused. This is an ideal situation for my idea since many of these stacks are in the 1000 foot high range.

2) The square surface area of the conduit from the base and up to the top.
The greater the square surface, the greater mass air flow, thus, the greater the amount of electricity that can be generated, or work that can be accomplished.
The conduit does not have to be round.
Any configuration that will allow air flow without severe restriction will work. Example: An abandoned elevator shaft in a relatively tall building would make a good conduit.

3) Geographical location.
Wind speed at higher elevation can become an important aspect of my idea since it can create a “venturi” effect and increase the mass air flow.
A gully up the side of a relative high mountain could be encapsulated to form a conduit and provide altitude density differential.

2. These three factors determine the amount of electricity that can be generated or the amount of mechanical work that can be accomplished.

1. Altitude density differential pressure can supply the force to power an electric generating facility or to provide the force to power a mechanical device. This would include new or retrofitted facilities.

2. Altitude differential wind speed can provide (or assist with providing) the force to generate electricity or to provide the force to power a mechanical device. This also would include new or retrofitted facilities.

3. This system would not require any fuel (or source of heat input). Once the capital cost is completed, this generator would provide relatively “free electricity”.

4. The environmental benefits have the potential of being quite significant.

5. There are no facilities that use claims 1, 2, or 3.
